(19) United States
(12) Patent Application Publication
(10) Pub. No.: US 2026/0089670 A1
(43) Pub. Date: Mar. 26, 2026

(54) LANDMARK BASED POSITIONING OPERATIONS

(71) Applicant: QUALCOMM Incorporated, San Diego, CA (US)

(72) Inventors: Bapineedu Chowdary GUMMADI, Hyderabad (IN); Stephen William EDGE, Escondido, CA (US); Lekhya Pavani GODAVARTHI, Hyderabad (IN)

(21) Appl. No.: 18/896,015

(22) Filed: Sep. 25, 2024

(51) Int. Cl. H04W 64/00

(52) U.S. Cl. CPC H04W 64/00

(57) ABSTRACT

An example method performed by a first user equipment (UE) for positioning can include obtaining information associated with one or more landmarks, determining an identification and/or a classification of at least one of the one or more landmarks, transmitting, to a configuring entity, the identification and/or the classification, and receiving, from the configuring entity, assistance data for performing a positioning procedure, wherein the assistance data is generated by the configuring entity based at least in part on the identification and/or the classification. The method can further include performing the positioning procedure based at least in part on the assistance data. In an example implementation, the identification and/or the classification provides an indication that a landmark among the one or more landmarks is either a man-made structure or a natural object.

### BACKGROUND

### 1. Field of Disclosure

The present disclosure relates generally to the field of position determination and more specifically pertains to position determination operations involving the use of one or more landmarks.

### 2. Description of Related Art

A position or a location of a user equipment (UE) such as, for example, a mobile phone, can be determined based on performing various types of position determination procedures. In an example scenario, a position determination procedure can be performed by the UE for determining the position of the UE. The position determination procedure can be performed either independently by the UE or by using assistance provided to the UE by another device (such as, for example, an access node of a cellular network).

In general, position determination procedures performed by a UE can be categorized under two broad categories as either non-cellular position determination procedures or cellular position determination procedures.

Some examples of non-cellular position determination procedures include satellite-based position determination procedures, sensor-based position determination procedures, and time-of-flight ranging procedures (for detecting objects).

Cellular-based position determination procedures typically involve interaction between the UE and one or more devices that may be a part of a cellular network (such as, for example, the Long Term Evolution (LTE) network and/or the 5G New Radio (NR) network). An example cellular-based position determination procedure involves positioning measurements made by use of, what is known as a positioning reference signal (PRS) that may be provided to the UE by an access node of a cellular network. The PRS may be used for performing measurements associated with techniques such as, for example, time of arrival (TOA), time difference of arrival (TDOA), angle of arrival (AOA), angle of departure (AOD), and received signal strength indicator (RSSI).

The various position determination procedures indicated above provide various levels of accuracy. In some cases, such as, for example, for cellular-based position determination procedures based on the 5G New Radio (NR) network, standards-based performance requirements may be specified on the basis of various service levels. Each service level may be characterized by parameters such as, for example, accuracy, service availability, and latency. Meeting such performance requirements typically requires the use of various types of technologies and techniques. Some of these technologies and techniques may only achieve a limited amount of success.

### BRIEF SUMMARY

Embodiments described herein pertain to position determination operations involving the use of one or more landmarks. An example method performed by a first user equipment (UE) for positioning can include obtaining information associated with one or more landmarks; determining at least one of an identification or a classification of at least one of the one or more landmarks; transmitting, to a configuring entity, the at least one of the identification or the classification; receiving, from the configuring entity, assistance data for performing a positioning procedure, wherein the assistance data is generated by the configuring entity based at least in part on the at least one of the identification or the classification; and performing the positioning procedure based at least in part on the assistance data.

An example first user equipment (UE) for performing positioning can include at least one transceiver; at least one memory; and one or more processors communicatively coupled with the at least one transceiver and the at least one memory. The one or more processors are configured to obtain, via the at least one transceiver, information associated with one or more landmarks; determine at least one of an identification or a classification of at least one of the one or more landmarks; transmit, via the at least one transceiver, to a configuring entity, the at least one of the identification or the classification; receive, via the at least one transceiver, from the configuring entity, assistance data for performing a positioning procedure, wherein the assistance data is generated by the configuring entity based at least in part on the at least one of the identification or the classification; and perform the positioning procedure based on configuring the first UE.

An example apparatus for providing location services can include means for means for obtaining information associated with one or more landmarks; means for determining at least one of an identification or a classification of at least one of the one or more landmarks; means for transmitting, to a configuring entity, the at least one of the identification or the classification; means for receiving, from the configuring entity, assistance data for performing a positioning procedure, wherein the assistance data is generated by the configuring entity based at least in part on the at least one of the identification or the classification; and means for performing the positioning procedure based at least in part on the assistance data.

An example method performed by a configuring entity for providing assistance data, the method comprising receiving, from a first user equipment (UE), at least one of an identification or a classification of at least one of one or more landmarks; generating, based at least in part on the at least one of an identification or a classification, at least one of a reference signal for performing a positioning procedure or assistance data for performing the positioning procedure; and transmitting, to the first UE, the at least one of the reference signal for performing the positioning procedure or assistance data for performing the positioning procedure.

An example configuring entity for providing assistance data, comprising at least one transceiver; at least one memory; and one or more processors communicatively coupled with the at least one transceiver and the at least one memory, the one or more processors configured to receive, via the at least one transceiver, from a first user equipment (UE), at least one of an identification or a classification of at least one of one or more landmarks; generate, based at least in part on the at least one of an identification or a classification, at least one of a reference signal for performing a positioning procedure or assistance data for performing the positioning procedure; and transmit, to the first UE, the at least one of the reference signal for performing the positioning procedure or assistance data for performing the positioning procedure.

An example apparatus for providing assistance data, the apparatus comprising means for receiving, from a first user equipment (UE), information about a landmark that is causing a disruption in a first mode of cellular communications used by the UE; means for generating, based at least in part on the information associated with the landmark, at least one of a reference signal for performing a positioning procedure or assistance data for performing the positioning procedure; and means for transmitting, to the first UE, the at least one of the reference signal for performing the positioning procedure or assistance data for performing the positioning procedure.

An example method performed by a first user equipment (UE) for positioning can include obtaining information associated with one or more objects and/or one or more environmental parameters; obtaining information about one or more landmarks based on inference drawn from the information associated with the one or more objects and/or one or more environmental parameters; classifying an environment based on the information about the landmark(s); transmitting, to a configuring entity, information about the classified environment; receiving, from the configuring entity, assistance data for performing a positioning procedure, wherein the assistance data is generated by the configuring entity based at least in part on the classified environment; and performing the positioning procedure based at least in part on the assistance data.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

The detailed description below pertains to a few example embodiments that are illustrated in the accompanying drawings. However, it must be understood that the description is equally relevant to various other variations of the embodiments described herein. Such embodiments may utilize objects and/or components other than those illustrated in the drawings. It must also be understood that like reference numerals used in the various figures indicate similar or identical objects.

FIG. 1 is a simplified illustration of a positioning system, according to an embodiment.

FIG. 2 is a diagram of a 5th Generation (5G) New Radio (NR) positioning system, illustrating an embodiment of a positioning system implemented within a 5G NR communication system.

FIG. 3 illustrates a first example signal flow scenario between a user equipment and a configuration entity that enables performing of a positioning operation based on landmark information.

FIG. 4 illustrates a second example signal flow scenario between a user equipment and a configuration entity that enables performing of a positioning operation based on landmark information.

FIG. 5 illustrates a third example signal flow scenario between a user equipment and a configuration entity that enables performing of a positioning operation based on landmark information.

FIG. 6 illustrates a fourth example signal flow scenario between a user equipment and a configuration entity that enables performing of a positioning operation based on landmark information.

FIG. 7 illustrates an example scenario wherein a configuration entity provides assistance information to a user equipment for optimizing a positioning operation in accordance with the disclosure.

FIG. 8 shows a flowchart of an example method to perform a positioning operation based on landmark information in accordance with the disclosure.

FIG. 9 is a diagram showing some example functional elements of a user equipment according to an embodiment.

FIG. 10 is a diagram showing some example functional elements of an access node according to an embodiment.

FIG. 11 is a block diagram of an embodiment of a computer system which may be used, in whole or in part, to provide the functions of one or more components and/or devices in accordance with the disclosure.

FIG. 12 shows a flowchart of an example method to perform a positioning operation based on environmental information in accordance with the disclosure.

### DETAILED DESCRIPTION

Several illustrative examples will now be described with respect to the accompanying drawings, which form a part hereof. While particular examples, in which one or more aspects of the disclosure may be implemented, are described below, other examples may be used, and various modifications may be made without departing from the scope of the disclosure or the spirit of the appended claims.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, particular features, structures, or characteristics described herein may be combined in one or more examples. It must be understood that words such as “position” and “positioning” are used in this disclosure interchangeably with words/phrases such as “location” and “location determination” and are intended to be equivalent in meaning and context.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

Various aspects described herein generally relate to systems and methods for performing positioning operations by use of landmarks. The word “landmark” as used herein in this disclosure generally refers to any object that adversely impacts cellular communications, particularly, cellular communications pertaining to a user equipment (UE) such as, for example, a cellular phone. A non-exhaustive list of landmarks can include, for example, walls, buildings, underground garages, subway stations, elevators, and various kinds of enclosed spaces that may block, attenuate, disrupt, and/or distort cellular communication signals. At least some UEs such as smartphones, for example, may be configured to detect a drop in cellular signal reception and switch from using a first mode of cellular communications (5G cellular communications, for example) where the drop in cellular signal reception is detected, to a second mode of cellular communications (3G cellular communications, for example) that may be less susceptible to disruption caused by the landmark (in spite of incurring a trade-off in performance such as, for example, a reduction in signal speed). Performing a switching operation to switch from use of a first mode of cellular communications to a second mode of cellular communications upon encountering an impact due to a landmark may avoid a significant disruption of communications services provided by the user equipment. In addition to providing communications services, the user equipment may be further configured to perform positioning operations. Positioning operations may also be impacted by landmarks and this disclosure addresses this issue.

More particularly, the various example embodiments disclosed herein generally pertain to incorporating landmark information into positioning operations. In an example embodiment, a UE may convey information about a landmark to a configuring entity (a location server, for example) when requesting assistance data for performing a positioning operation. In an example implementation, the landmark information that is conveyed to the configuring entity may be selected from among a set of predesignated or preselected landmarks. The predesignated landmarks, which can be landmarks in a defined area (town, county, city, locality, etc.), can include, for example, a shop, a mall, a hotel, a convention center, an auditorium, a hospital, a library, a cinema house, an office, a park, a forest, a golf course, a sports stadium, a concert hall, or a restaurant.

The configuring entity may generate assistance data based on the landmark information, such as, for example, based on identifying one or more access nodes suitable for providing positioning-related services to the UE, scheduling delivery of a positioning reference signal (PRS) to the UE by an access node, indicating a measurement schedule, indicating a measurement periodicity, muting PRS, intelligent cell selection, smart network selection, etc. The assistance data, which can include information pertaining to one or more of the aspects indicated above (identifying one or more access nodes, scheduling delivery of a PRS, etc.), may be received by the UE from the configuring entity and used for performing a positioning operation.

In another example embodiment, a UE can provide landmark information classifying an environment and provide this to the configuring entity. The classifying action may be performed in various ways such as, for example, by use of an imaging device, use of sensor devices, artificial intelligence, and/or machine learning. In some cases, a UE may provide crowdsourced information to be associated with the landmark information. The configuring entity may generate assistance data based on the landmark information and/or the crowdsourced information.

Accordingly, particular aspects of the subject matter described in this disclosure can be implemented to realize one or more of the potential advantages described below.

An example advantage associated with incorporating landmark information into positioning operations in the manner described herein may allow for mitigation or elimination of delays, interruptions, and/or other undesirable effects caused by a landmark upon positioning operations. More particularly, preemptively identifying and detecting a landmark and preparing to take measures to counter an adverse effect of the landmark upon a positioning operation allows for more efficient execution of the positioning operation.

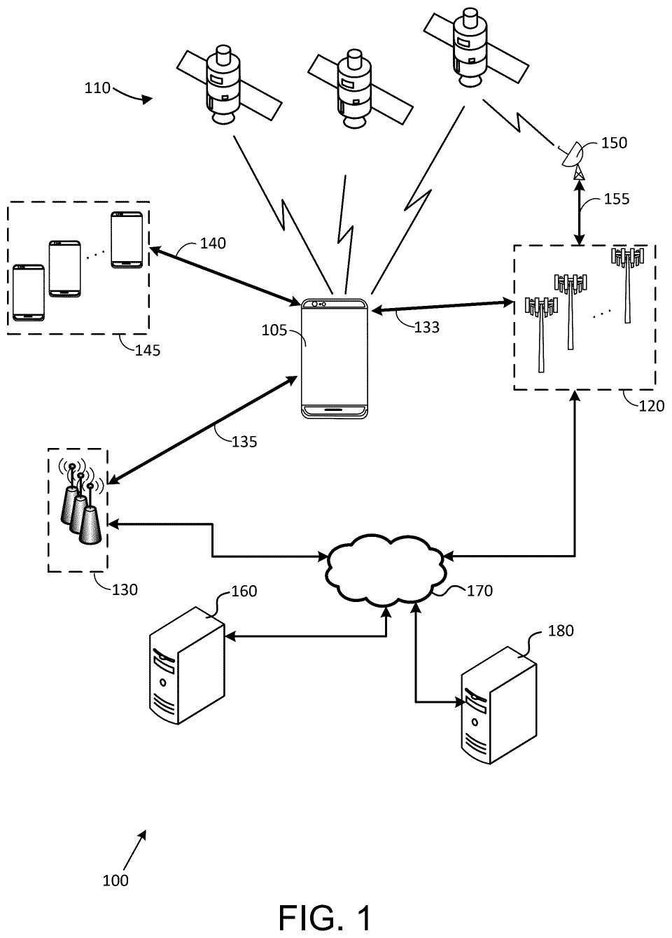

FIG. 1 is a simplified illustration of a positioning/sensing system 100, which may be implemented in conjunction with and/or as part of a wireless communication system (e.g., cellular communication network) and can include a mobile device 105, a location server 160, and/or other components. One or more components of the positioning/sensing system 100 can be used for implementing the techniques disclosed herein for performing positioning operations by use of landmarks. However, the techniques described herein are not limited to such components and may be implemented in other types of systems (not shown). The positioning/sensing system 100 can include: the mobile device 105 (which is one example of an UE); one or more satellites 110 (also referred to as space vehicles (SVs)) for a Global Navigation Satellite System (GNSS) (such as the Global Positioning System (GPS), GLONASS, Galileo or Beidou) and/or Non-Terrestrial Network (NTN) functionality; base stations 120; access points (APs) 130; location server 160; network 170; and external client 180. Generally put, the positioning/sensing system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms) can be utilized to perform positioning (e.g., of one or more wireless devices) and/or to perform RF sensing (e.g., of one or more objects by using RF signals transmitted by one or more wireless devices).

It should be noted that FIG. 1 provides only a generalized illustration of various components, any or all of which may be utilized as appropriate, and each of which may be duplicated, as necessary. Specifically, although only one mobile device 105 is illustrated, it will be understood that many UEs (e.g., hundreds, thousands, millions, etc.) may utilize the positioning/sensing system 100. Similarly, the positioning/sensing system 100 may include a larger or smaller number of base stations 120 and/or APs 130 than illustrated in FIG. 1. The illustrated connections that connect the various components in the positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). In an LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base stations 120 may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), a New Radio (NR) NodeB, a Next Generation Node B (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components.

An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145. As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” used herein may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the mobile device 105 to communicate with the network 170 via satellites 110, but this can also enable network-based positioning, RF sensing, etc.

Satellites 110 may be utilized in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server that may operate as a location server. In some embodiments, satellites 110 used for NTN-based positioning may be different than those used for GNSS-based positioning. In some embodiments NTN nodes may include non-terrestrial vehicles, which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

As used herein, the term “cell” may generically refer to a logical communication entity used for communication with a base station 120 and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted, an estimated location of the mobile device 105 may be based on measurements of RF signals sent from and/or received by the mobile device 105. In particular, these measurements can provide information regarding the relative distance and/or angle of the mobile device 105 from one or more components in the positioning/sensing system 100 (e.g., satellites 110, APs 130, base stations 120). The estimated location of the mobile device 105 can be estimated geometrically (e.g., using multiangulation and/or multilateration), based on the distance (range) and/or angle measurements, along with known position of the one or more components.

Additionally or alternatively, the location server 160, may function as a sensing server. A sensing server can be used to coordinate and/or assist in the coordination of sensing of one or more objects (also referred to herein as “targets”) by one or more wireless devices in the positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF or SnMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra-Wideband (UWB), IEEE 802.15x, or a combination thereof. Mobile devices 145 may additionally or alternatively use non-RF wireless signals for positioning of the mobile device 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular mobile device 105, the mobile device 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate,” “estimated location,” “location,” “position,” “position estimate,” “position fix,” “estimated position,” “location fix” or “fix.” The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

As previously noted, the example positioning/sensing system 100 can be implemented using a wireless communication network, such as an LTE-based or 5G NR-based network, or a future 6G network.

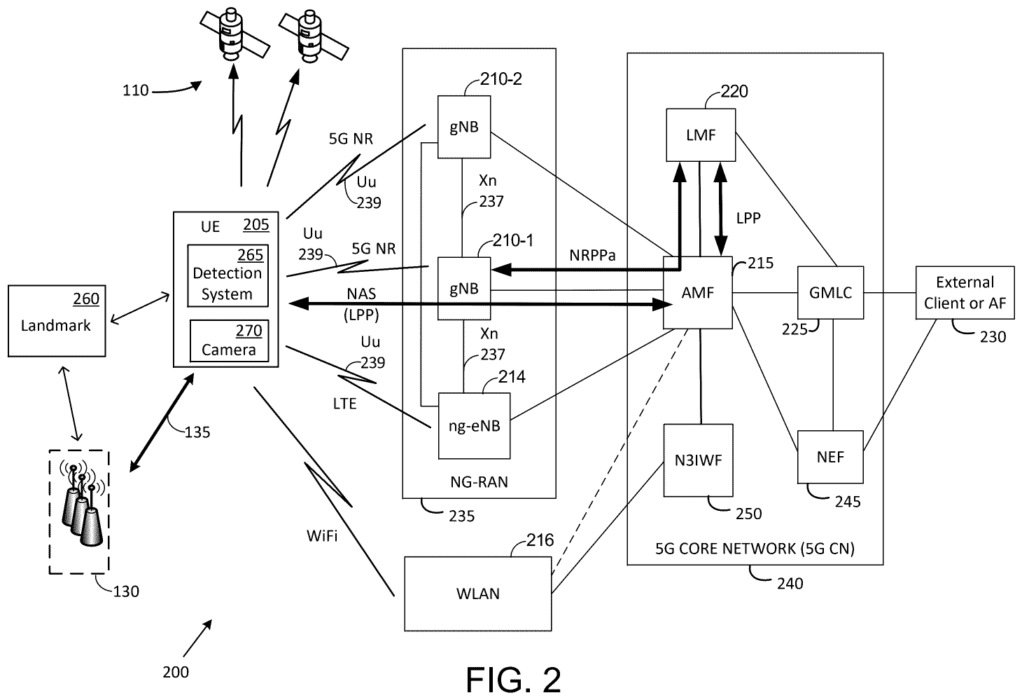

FIG. 2 shows a diagram of a 5G NR positioning/sensing system 200, illustrating an embodiment of a positioning/sensing system (e.g., positioning/sensing system 100) implementing 5G NR. The 5G NR positioning/sensing system 200 may be configured to determine the location of a UE, such as, for example, the mobile device 105, by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning/sensing system 200 additionally may be configured to determine the location of a UE 205 (such as, for example, the mobile device 105 shown in FIG. 1) by using a location server such as, for example, the LMF 220 (which may correspond with location server 160) to implement the one or more positioning methods. Here, the 5G NR positioning/sensing system 200 comprises the UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning/sensing system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning/sensing system 200 are described below. The 5G NR positioning/sensing system 200 may include additional or alternative components.

It should be noted that FIG. 2 provides only a generalized illustration of various components, any or all of which may be utilized as appropriate, and each of which may be duplicated or omitted as necessary. Specifically, although only one UE 205 is illustrated, it will be understood that many UEs (e.g., hundreds, thousands, millions, etc.) may utilize the 5G NR positioning/sensing system 200. Similarly, the 5G NR positioning/sensing system 200 may include a larger (or smaller) number of GNSS satellites 110, gNBs 210, ng-eNBs 214, Wireless Local Area Networks (WLANs) 216, Access and mobility Management Functions (AMF) s 215, external client 230, and/or other components. The illustrated connections that connect the various components in the 5G NR positioning/sensing system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning/sensing system 200, such as the LMF 220 and AMF 215.

5G NR positioning/sensing system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning/sensing system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with a LMF 220. The AMF 215 may support mobility of the UE 205, including cell change and handover of UE 205 from an access node (e.g., gNB 210, ng-eNB 214, or WLAN 216) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AOA), angle of departure (AoD), WLAN positioning, round trip signal propagation delay (RTT), multi-cell RTT, and/or other positioning operations and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such as gNBs 210, ng-eNB 214 and/or WLAN 216, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE based position methods such as A-GNSS, RTK, TDOA, multi-cell RTT, AoD, and/or ECID. The NRPPa protocol may be used to support positioning of UE 205 using network based position methods such as ECID, AOA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE assisted or UE based positioning of UE 205 by LMF 220.

In a 5G NR positioning/sensing system 200, positioning methods can be categorized as being “UE assisted” or “UE based.” This may depend on where the request for determining the position of the UE 205 originated. If, for example, the request originated at the UE (e.g., from an application, or “app,” executed by the UE), the positioning method may be categorized as being UE based. If, on the other hand, the request originates from an external client or AF 215, LMF 220, or other device or service within the 5G network, the positioning method may be categorized as being UE assisted (or “network-based”).

With a UE-assisted position method, UE 205 may obtain location measurements and send the measurements to a location server (e.g., LMF 220) for computation of a location estimate for UE 205. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AOA, Receive Time-Transmission Time Difference (Rx-Tx), Differential AOA (DAOA), AOD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 205 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 205 may obtain location measurements (e.g., which may be the same as or similar to location measurements for a UE assisted position method) and may further compute a location of UE 205 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AOA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, that is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AOD or AOA.

The example 5G NR positioning/sensing system 200 further illustrates a landmark 260. The landmark 260 can be any of various objects that may have an adverse impact upon communication operations and positioning operations performed by the UE 205. The adverse impact can be, for example, a disruption in a mode of cellular communications used by the UE 205 (cellular signal blockage, cellular signal attenuation, cellular signal distortion, etc.). A non-exhaustive list of elements represented by the illustration of the landmark 260 can include, walls, buildings, underground garages, subway stations, elevators, various kinds of vehicles, and various kinds of enclosed spaces that may block, attenuate, disrupt, and/or distort cellular communication signals.

In an example embodiment, the UE 205 obtains information about the landmark 260 and transmits the information to a configuring entity such as, for example, an access node (gNB 210-1, ng-eNB 214, for example), or a location server (LMF 220, for example), in order to seek help from the configuring entity for performing a positioning operation in view of the disruption caused by the landmark 260.

In an example implementation, the landmark information that is conveyed to the configuring entity may be selected from among a set of predesignated or preselected landmarks. The predesignated landmarks can include, for example, some, or all portions, of a shop, a mall, a hotel, a convention center, an auditorium, a hospital, a library, a cinema house, an office, a park, a forest, a golf course, a sports stadium, a concert hall, or a restaurant. In an example implementation, the predesignated landmarks may be selected from within a selected area, such as, for example, a town, a county, a city, a locality, a subdivision, a tourist attraction, or a travel area. In an example implementation, the UE 205 obtains information about the landmark 260 from a predefined list of landmark types. The landmark types may be classified, for example, in a manner similar to that used for the set of predesignated or preselected landmarks indicated above (a man-made structure or a natural object, such as, for example, a shop, a mall, a hotel, a convention center, an auditorium, a hospital, a library, a cinema house, an office, a park, a forest, a golf course, a sports stadium, a concert hall, or a restaurant).

Information about the landmark 260 may be obtained by the UE 205 in any of various ways. In an example scenario, the UE 205 obtains one or more images of the landmark 260 by use of a camera 270. A processor (not shown) that can be included in the UE 205 can obtain information about the landmark 260 based on the image(s) such as, for example, based on evaluating the image(s). Evaluating can be performed in various ways such as, for example, by applying image processing techniques and/or employing computer vision techniques (artificial intelligence (AI), machine learning, and/or neural networks). In an example implementation, the evaluation is directed at identifying, classifying, and/or characterizing the landmark 260. In an example scenario, the landmark 260 may be identified as a railway tunnel, an interior section of a vehicle, or an underground garage. Evaluating the image(s) can further include determining whether the landmark 260 may have an adverse impact upon execution of a positioning procedure such as, for example, whether the landmark 260 may have an adverse impact upon wireless signals used for the positioning procedure. A few examples of wireless signals can include cellular signals and non-cellular signals that can be used in a positioning procedure.

As indicated above, in one scenario, a positioning procedure can involve positioning measurements made by use of, what is known as a positioning reference signal (PRS) that may be provided to the UE by an access node (such as, for example, gNB 210-1 or ng-eNB 214). The PRS may be used for performing measurements associated with techniques such as, for example, time of arrival (TOA), time difference of arrival (TDOA), angle of arrival (AOA), angle of departure (AOD), and received signal strength indicator (RSSI).

Information about the landmark 260 may also be obtained by the UE 205 based on sensor measurements obtained from a detection system 265. In an example scenario, detection system 265 can include elements such as, for example, a camera, a microphone, and a sensor. Audio signals produced by the microphone may be evaluated by a processor (not shown) in the UE 205 in order to identify, classify, and/or characterize the landmark 260. In an example scenario, the landmark 260 may be identified as a railway tunnel based on identifying one or more audio signals provided by the microphone as sounds produced by a train (whistle, track sounds, railcar sounds, echoes/reverberations from walls, etc.).

Evaluating sensor signals can include the use of artificial intelligence/machine learning (AI/ML) procedures for identifying the landmark 260 such as, for example, to interpret and/or analyze audio signals obtained from a microphone. For example, AI/ML tools (and/or other tools) may be used to analyze a sound that could be a train whistle and recognize that the sound is indeed a train whistle and based on one or more audio signatures/templates (echo characteristics, reverberation characteristics, spectral characteristics, etc.) the train whistle is occurring inside a railway tunnel. Additional sensor measurements such as, for example, associated with environmental conditions (temperature, humidity, air pressure, etc.) may be used to collaborate findings such as based on evaluating audio signals.

Training material for performing the AI/ML procedures can include audio samples obtained from various sources such as, for example, from one or more other UEs, from area maps, and via crowdsourcing from various entities. The audio samples may be obtained by use of microphones located in various types of landmark 260 (inside a railway tunnel, airport, underground garage, restaurant, etc.). The training material for performing the AI/ML procedures can also involve template images of various landmarks that may be used for image processing operations using AI/ML for identifying the landmark 260.

Information about the landmark 260 may also be obtained by the UE 205 based on detecting one or more devices and/or communicating with one or more other devices such as, for example, one or more access points and/or one or more other UEs. In an example implementation, an entity such as for example, the APs 130, may detect a landmark, obtain information about the landmark, and convey the information to the UE 205 (in the form of crowdsourced information, for example). In another example implementation, the UE 205 may communicate with entities such as, for example, the APs 130 (via the second communication link 135) and associate the landmark 260 with one or more access points. For example, UE 205 may communicate with an access point (APs 130) over the second communication link 135 via Wi-Fi communications (i.e. non-cellular communications), and convey to a configuring entity (an access node or a location server) a message that includes information indicating that the access point is located inside the landmark 260. The access point can be, for example, a wi-fi router located inside a building (one example of the landmark 260).

The UE 205 may also provide to the configuring entity, additional information about the access point such as, for example, an IP address of the access point. The configuring entity may, in at least some implementations, have knowledge of a location of the landmark 260 of other objects based on a map of the area in which the landmark 260 and the APs 130 are located.

In an example implementation, the UE 205 may select and use a priority scheme that is based on prioritizing the use of various devices for performing a positioning operation. Thus, in an example scenario, the UE 205 may include the APs 130 and one or more access nodes in the priority list and may prioritize the APs 130 at a higher level than an access node, for purposes of performing a positioning procedure. The positioning procedure may be performed by use of non-cellular signals such as, for example, WiFi signals and mm Wave signals.

Positioning operations may be performed by various entities (including the UE 205) in the various example ways described above with reference to the 5G NR positioning/sensing system 200 shown in FIG. 2. In accordance with the disclosure, the assistance data used for performing a positioning operation is specifically determined by the LMF 220 and/or an access node (such as, for example, gNB 210-1 or ng-eNB 214) based on the landmark 260. This aspect is described below in more detail using another figure.

Positioning operation results of a positioning operation may be provided to one or more of various entities. In an example implementation, positioning operation results in the form of position estimates may be transmitted by the UE 205 to a client such as, for example, external client 180 of FIG. 1 or external client 230 of FIG. 2) via the Gateway Mobile Location Center (GMLC) 225. In an example implementation, the location estimate may be provided to a client entity such as, for example, the LMF 220 and/or the external client 230, together with information of the landmark 260 such as, for example, “UE 205 is located at latitude/longitude (X/Y) in an airport.” In an example implementation, location estimate and/or landmark information may be provided to the client together with an indication of an uncertainty level associated with the location estimate and/or landmark information such as, for example, “UE 205 is estimated to be located at latitude/longitude (X/Y) in an airport with an 10% uncertainty level associated with the location estimate and/or landmark information.” Conversely, location estimate and/or landmark information may be provided to the client together with an indication of a certainty level associated with the location estimate and/or landmark information such as, for example, “UE 205 is estimated with a 90% certainty level to be located at latitude/longitude (X/Y) in an airport.” In an example implementation, the LMF 220 may perform additional operations to minimize an uncertainty level (or to optimize a certainty level) such as, for example, by using information about the landmark 260 that is obtained from one or more other entities such as, for example, one or more WiFi APs and/or one or more other UEs that may be located at less than a preselected distance from the UE 205 and/or inside a predefined cell coverage area that is applicable to the UE 205.

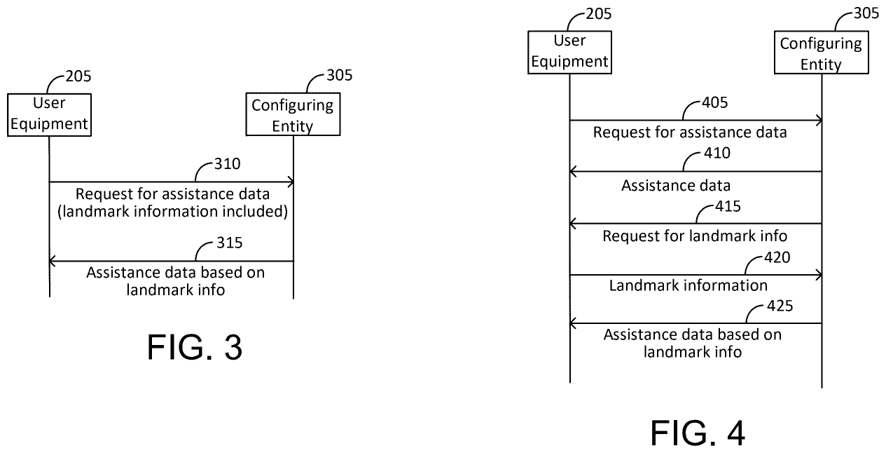

FIG. 3 illustrates a first example signal flow scenario between a user equipment and a configuration entity that enables performing of a positioning operation based on landmark information. In this example (and in other examples described below with reference to FIG. 4 through FIG. 6), the user equipment is the user equipment 205 described above and the configuring entity 305 can be, for example, an access node (gNB 210-1, ng-eNB 214, for example) or a location server (LMF 220, for example). The interactions between the UE 205 and the configuring entity 305 may be carried out using any of various communication formats that support messaging and data transport.

More particularly, the example signal flow scenario pertains to the UE 205 performing a location determination procedure based on providing to the configuring entity 305, information about a landmark. As a part of the location determination procedure, the UE 205 may transmit to the configuring entity 305 a request for assistance data (arrow 310). The request includes information about the landmark. In an example implementation, the request may be transmitted in a message conforming to LTE Positioning Protocol (LPP). An example message for the request can be as follows:

RequestAssistanceData-IEs ::== SEQUENCE {landmarkinfo {elevator, subway,
garage, mountain, airport, . . .}.

The configuring entity 305 responds to the request my transmitting to the UE 205, assistance data that is tailored on the basis of the provided landmark information. The transmitting action is indicated by arrow 315. In an example scenario, the assistance data may provide information about devices such as, for example, access nodes and APs that are located near the landmark or located inside the landmark (inside a railway tunnel, for example).

FIG. 4 illustrates a second example signal flow scenario between a user equipment and a configuration entity that enables performing of a positioning operation based on landmark information. Unlike the scenario described above with reference to FIG. 3, in this example scenario, the UE 205 transmits a request for assistance data (arrow 405) that does not contain landmark information. The configuring entity 305 responds to the request by transmitting to the UE 205 (arrow 410) assistance data that does not involve the use of a landmark. The configuring entity 305 may further transmit to the UE 205 (arrow 415) a request for landmark information.

In at least some cases, the request for landmark information may be transmitted by the configuring entity 305 to the UE 205, independent of the actions indicated by arrow 405 and arrow 410. For example, in a first scenario, the configuring entity 305 transmits the request to the UE 205 after the actions indicated by arrow 405 and arrow 410 are carried out. In a second scenario, the configuring entity 305 transmits the request to the UE 205 even if the actions indicated by arrow 405 and arrow 410 are not carried out.

In an example implementation, the request for landmark information may be transmitted by the configuring entity 305 to the UE 205 in a message conforming to LTE Positioning Protocol (LPP). An example message for the request can be as follows:

ProvideLocationInformation-IEs ::== SEQUENCE {landmarkinfo {elevator,
subway, garage, mountain, airport, . . .}.

The UE 205 responds to the request for landmark information received from the configuring entity 305 by transmitting to the configuring entity 305, the landmark information (arrow 420). The configuring entity 305 may subsequently transmit to the UE 205, assistance data that is tailored on the basis of the provided landmark information. The transmitting action is indicated by arrow 425. In an example scenario, the assistance data may provide information on how to perform the location determination procedure in view of the landmark.

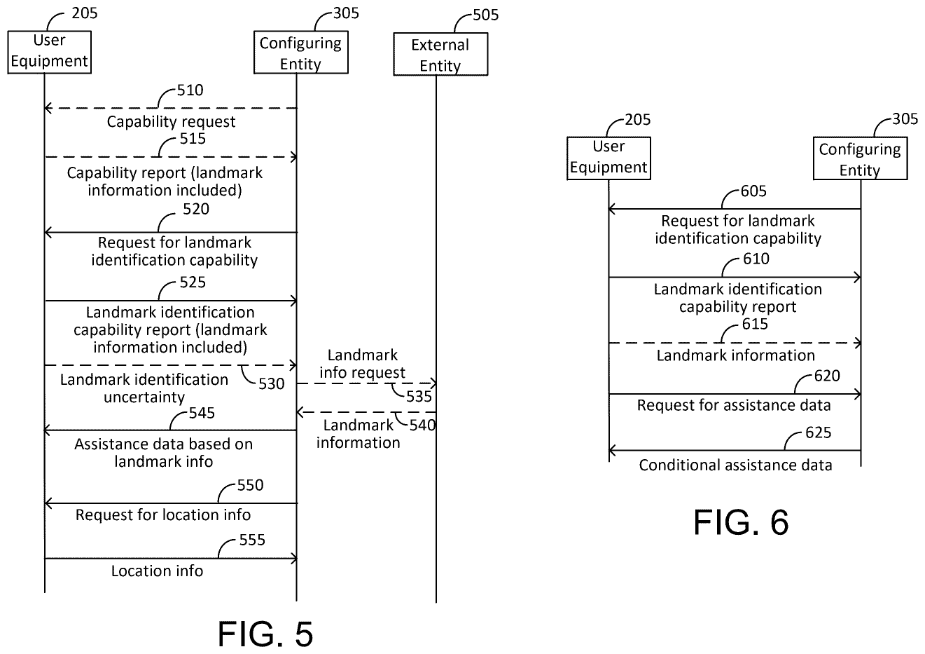

FIG. 5 illustrates a third example signal flow scenario between a user equipment and a configuration entity that enables performing of a positioning operation based on landmark information. In this example scenario, the configuring entity 305 may perform an optional step that involves sending a capability request to the UE 205 (arrow 510). The UE 205 may respond to the capability request by transmitting to the configuring entity, a capability report (arrow 515). The capability report can include information about one or more landmarks that may have an adverse impact upon wireless signals used for the positioning operation.

If the optional actions indicated above (arrow 510 and arrow 515) are not performed, the configuring entity 305 can transmit to the UE 205, a request for landmark identification capability of the UE 205 (arrow 520). An example message for the request can be as follows:

ProvideCapabilities-IEs ::== SEQUENCE {landmarkinfo {elevator, subway,
garage, mountain, airport, . . .}.

The UE 205 responds to the request by transmitting to the configuring entity 305, a message indicating the landmark identification capability of the UE 205 (arrow 525). In an example scenario, the landmark identification capability of the UE 205 may be indicated in the form of a binary response (either supported or not supported). In another example scenario, the landmark identification capability of the UE 205 may be indicated in the form of components (camera, sensor, communication systems, etc.) available to the UE 205, capabilities of such components (sensing capabilities, resolution, types of data/information handled, communication formats, etc.), and/or data evaluating capabilities of the UE 205 (software, AI/ML tools, etc. for evaluating images and/or sensor signals, etc.).

As an optional action, the UE 205 may also transmit to the configuring entity 305, a message that indicates a landmark identification uncertainty (arrow 530). In an example implementation, a landmark identification uncertainty may be indicated in the form of a percentage value or based on weighting.

Upon receiving the optional message (arrow 530) that indicates a landmark identification uncertainty, the configuring entity 305 may obtain complementary, supplementary, or replacement landmark information from an external entity 505. In an example implementation, a landmark information request may be transmitted (arrow 535) by the configuring entity 305 to the external entity 505. The external entity 505 can be, for example, the external client 230 shown in FIG. 2. The external entity 505 may respond to the landmark information request by transmitting landmark information (arrow 540) to the configuring entity 305.

The configuring entity 305 may use the landmark information to produce assistance data that is customized based on the landmark information, and transmits the customized assistance data to the UE 205 (arrow 545). In an example scenario, the assistance data may include information on how to use one or more specific landmarks for performing the location determination procedure and/or additional information pertaining to the landmark, such as, for example, that the landmark is a railway tunnel extending “x” meters (based on information obtained by the configuring entity 305 via crowdsourcing, for example). In another example scenario, the assistance data may include information about one or more devices that can be used by the UE 205 for location determination. The device(s) can be selected by the configuring entity 305 based on the device(s) being located inside a defined geographic area (limited to inside the railway tunnel, for example). In one case, the geographic area can correspond to a cellular coverage area where cellular communications are available for use by the UE 205 to perform a positioning procedure. Devices located outside the defined geographic area may be unsuitable for use by the UE 205 due to various reasons such as, for example, due to being unable to offer an acceptable level of accuracy in a location determination procedure performed by the UE 205.

In an example scenario, the configuring entity 305 may transmit to the UE 205, a request for location information (arrow 550). The UE 205 may respond to the request for location information by transmitting to the configuring entity 305, location information (arrow 555). The location information may, for example, be location information of the UE 205.

FIG. 6 illustrates a fourth example signal flow scenario between a user equipment and a configuration entity that enables performing of a positioning operation based on landmark information. The actions indicated by arrow 510 and arrow 515 in FIG. 5 may be optionally performed in this signal flow scenario as well. The configuring entity 305 can transmit to the UE 205, a request for landmark identification capability of the UE 205 (arrow 605) and receive from the UE 205, a response in the form of a landmark identification capability report (arrow 610). However, in an example implementation, the actions indicated by arrow 605 and arrow 610 can be omitted and landmark information may, for example, be included in a capability report submitted by the UE 205 to the configuring entity 305 (in response to, or irrespective of, a capability request being transmitted by the configuring entity 305 to the UE 205).

The action indicated by arrow 615 can be an optional step where the UE 205 provides landmark information to the configuring entity 305. The landmark information may, for example, be information obtained by the UE 205 by use of detection system 265 or in other ways as described above. The UE 205 may transmit to the configuring entity 305, a request for assistance data (arrow 620). The configuring entity 305 may respond to the request for assistance data by transmitting to the UE 205, what is referred to herein as conditional assistance data (arrow 625). The conditional assistance data is produced by the configuring entity 305 based on information contained in the landmark identification capability report provided by the UE 205 to the configuring entity 305 (indicated by arrow 610) and/or based on information received from one or more other entities such as, for example, one or more gNBs 210 (shown in FIG. 2).

In an example scenario, the conditional assistance data may include one or more conditions and/or one or more restrictions placed upon the UE 205 when the UE 205 performs a location detection procedure at the location where the landmark is detected. An example usage condition (where a landmark has been detected) may be: “Use X, Y, and/or Z cells (one or more cells specified in the assistance data) of A, B, and/or C cellular network (one or more cellular networks specified in the assistance data) when at the location where the landmark is detected.” An example prioritization condition may indicate: “Prioritize the use of one or more cells (specified in the assistance data) of a cellular network (specified in the assistance data) when at the location where the landmark is detected.” The conditional assistance data may be helpful to UE 205 in various ways, such as, for example, by eliminating unnecessary positioning measurements using sub-optimal or unsuitable cells.

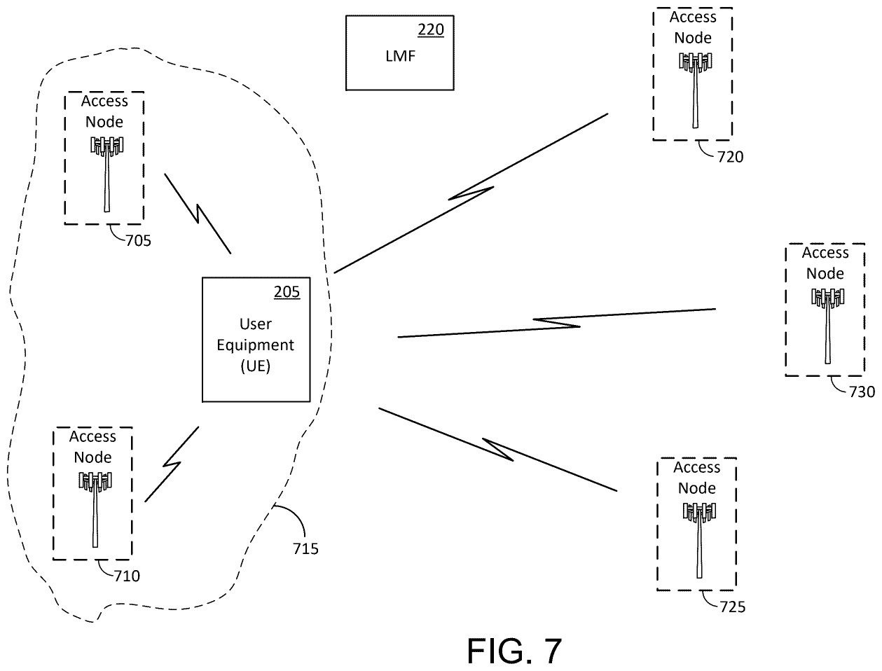

FIG. 7 illustrates an example scenario wherein a configuration entity provides assistance information to a user equipment for optimizing a positioning operation in accordance with the disclosure. The assistance information is provided in the form of conditional assistance data that is described above. The conditional assistance data may provide an indication to the UE 205 to use one or more specified access nodes (described above with reference to base stations 120 shown in FIG. 1). In the illustrated example scenario, the conditional assistance data may be transmitted to the UE 205 by the LMF 220, and may provide an indication to the UE 205 to use an access node 705 and an access node 710. The LMF 220 may make a determination regarding use of the access node 705 and the access node 710 by the UE 205, based on various factors. A first example factor may be attributed to the landmark 715 being a railway tunnel with limited cellular coverage availability. Other access nodes such as, for example, an access node 720, an access node 730, and an access node 725 may be located too far for use by the UE 025, furthermore because the UE 205 is located inside the railway tunnel. The UE 205 may perform a positioning operation in cooperation with the access node 705 and/or the access node 710, such as, for example, by receiving a reference signal from one of the access node 705 or the access node 710. Some examples of a reference signal may include a Sounding Reference Signal (SRS), a Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc.

In an example implementation, the LMF 220 may form, what is referred to herein, as a cluster. In the illustrated example, a cluster can include the access node 705 and the access node 710. In some cases some of the access nodes of a first cluster may be shared with a second cluster, where the second cluster is useable by another UE other than the UE 205.

In an example implementation, the LMF 220 may select the elements of a cluster based on identifying a signal strength exceeding a threshold signal strength. The threshold signal strength may be selected based on the landmark 715.

Using the conditional assistance data in the manner described above may be helpful to UE 205 in various ways, such as, for example, by eliminating unnecessary positioning measurements using sub-optimal or unsuitable cells associated with, for example, the access node 720, the access node 730, and the access node 725.

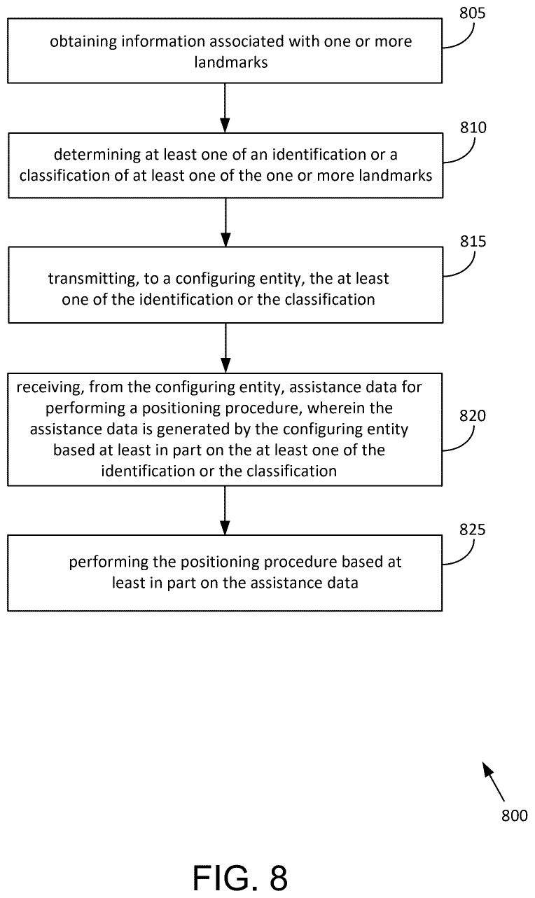

FIG. 8 shows a flowchart 800 of an example method to perform a positioning operation based on landmark information in accordance with the disclosure. Means for performing the functionality illustrated in one or more of the blocks of the flowchart 800 may be performed by hardware and/or software components of a user equipment such as described herein with reference to the UE 205.

At block 805, the functionality can include obtaining information associated with one or more landmarks such as, for example, obtaining information associated with the landmark 260 described herein. Means and/or structure for performing functionality at block 805 may comprise a UE that includes a detection system (such as, for example UE 205 that includes the detection system 265 as illustrated in FIG. 2). In an example embodiment, information associated with the landmark(s) can be obtained by use of the detection system 265 described above. Thus, for example, the information can be based on one or more images captured by a camera, one or more audio signals obtained via a microphone, one or more sensor signals obtained from a sensor, crowdsourced information about the landmark(s) that is received from one or more entities, and/or location measurements associated with the landmark(s).

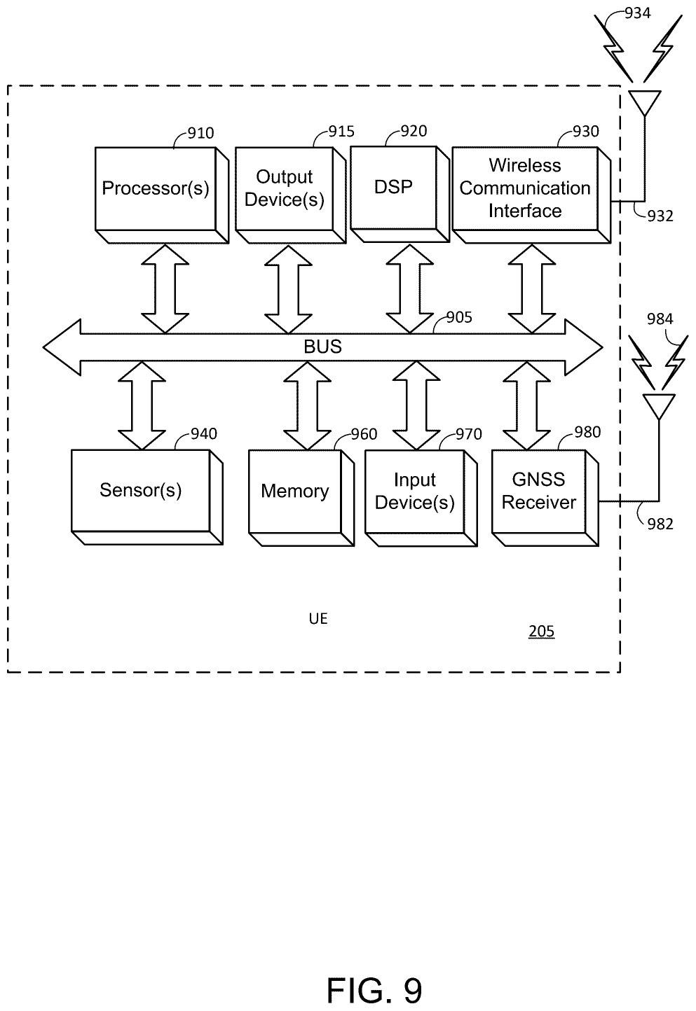

At block 810, the functionality can include determining at least one of an identification or a classification of at least one of the landmark among the one or more landmarks. Means and/or structure for performing functionality at block 810 may comprise a UE that includes a processor and a memory (such as, for example UE 205 that includes the processor(s) 910 and the memory 960 as illustrated in FIG. 9). In an example implementation, a UE can determine an identification, a classification, or an environment associated with a landmark, in various ways such as, for example, by use of an imaging device, use of sensor devices, use of artificial intelligence, and/or use of machine learning. In another example implementation, a landmark may be identified and/or classified based on historical information that the UE may have obtained over a period of time and stored in a memory (memory 960, for example). In another example implementation, a landmark may be identified and/or classified based on data provided by one or more entities such as, for example, an access node, and/or crowdsourced information provided by one or more other UEs.

At block 815, the functionality can include transmitting, to a configuring entity, the identification and/or the classification. Means and/or structure for performing functionality at block 810 may comprise a UE that includes a transmitter (or transceiver), such as, for example UE 205 that includes a wireless communication interface 930 illustrated in FIG. 9 and described below.

At block 820, the functionality can include receiving, from the configuring entity, assistance data for performing a positioning procedure, wherein the assistance data is generated by the configuring entity based at least in part on the identification and/or the classification of the landmark(s). Means and/or structure for performing functionality at block 820 may comprise a UE that includes a receiver (or transceiver) such as, for example UE 205 that includes a wireless communication interface 930 illustrated in FIG. 9 and described below. In an example scenario, the assistance data may provide information about devices such as, for example, access nodes and APs that are located near the landmark or located inside the landmark (inside a railway tunnel, for example). In an example scenario, the assistance data, which can may be tailored on the basis of the provided landmark information, may provide information on how to perform the location determination procedure in view of the landmark.

At block 825, the functionality can include performing the positioning procedure based on the assistance data received from the configuring entity. Means and/or structure for performing the functionality at block 820 may comprise a UE that includes a processor and a memory (such as, for example UE 205 that includes the processor(s) 910 and the memory 960 as illustrated in FIG. 9). In an example implementation, the UE may perform the positioning procedure based on using a reference signal that is indicated as information in the assistance data. The reference signal may be provided by an entity such as, for example, gNB 210.

FIG. 9 is a diagram showing some example functional elements of the UE 205 according to an embodiment. The illustrated example pertains to an embodiment of the UE 205 that can be utilized as described herein with reference to FIGS. 1-8. It should be noted that FIG. 9 is meant only to provide a generalized illustration of various components, any or all of which may be utilized as appropriate. It can be noted that, in some instances, components illustrated by FIG. 9 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 9.

The UE 205 is shown comprising hardware elements that can be electrically coupled via a bus 905 (or may otherwise be in communication, as appropriate). The hardware elements may include a processing unit(s) 910 which can include without limitation one or more general-purpose processors, one or more special-purpose processors (such as DSP chips, graphics acceleration processors, application specific integrated circuits (ASICs), and/or the like), and/or other processing structures or means. As shown in FIG. 9, some embodiments may have a separate DSP 920, depending on desired functionality. Location determination authentication, spoofing detection, and/or other operations that may be based on wireless communication can be provided in the processing unit(s) 910 and/or wireless communication interface 930 (discussed below). The UE 205 can also include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The UE 205 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 205 to communicate with other devices such as, for example, the base stations 120 described in the embodiments above. The wireless communication interface 930 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 932 that send and/or receive wireless signals 934. According to some embodiments, the wireless communication antenna(s) 932 may comprise a plurality of discrete antennas, antenna arrays, or a combination thereof.

Depending on desired functionality, the wireless communication interface 930 may comprise a separate receiver and transmitter, or a combination of transceivers, transmitters, and/or receivers to communicate with base stations (e.g., ng-eNBs and gNBs) and other terrestrial transceivers, such as wireless devices and access points. The term “transceiver” as used herein can refer to a component that can be a transmitter, a receiver or can have both functionalities, but is not limited to requiring both. In some implementations, a transceiver can be an integrated component that includes both a transmitter and a receiver. In some implementations, a transceiver can be provided in the form of two distinct components-a transmitter and a receiver. The UE 205 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000, WCDMA, and so on. CDMA2000 includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. Cdma2000 is described in documents from a consortium named “3rd Generation Partnership Project 3” (3GPP2). 3GPP and 3GPP2 documents are publicly available. A WLAN may also be an IEEE 802.11x network, and a wireless personal area network (WPAN) may be a Bluetooth network, an IEEE 802.15x, or some other type of network. The techniques described herein may also be used for a combination of WWAN, WLAN and/or WPAN.

The UE 205 can further include sensor(s) 940. Sensors 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), at least some of which may be used to detect landmarks in accordance with the disclosure.

Embodiments of the UE 205 may also include a Global Navigation Satellite System (GNSS) receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the UE 205, using conventional techniques, from GNSS satellites 110 of a GNSS system, such as Global Positioning System (GPS), Galileo, GLONASS, Quasi-Zenith Satellite System (QZSS) over Japan, Indian Regional Navigational Satellite System (IRNSS) over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processing units, such as processing unit(s) 910, DSP 920, and/or a processing unit within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processing units, such as processing unit(s) 910 or DSP 920.

The UE 205 may further include and/or be in communication with a memory 960. The memory 960 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the UE 205 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the UE 205 (and/or processing unit(s) 910 or DSP 920 within UE 205). In an aspect, then such code and/or instructions can be used to configure and/or adapt a general-purpose computer (or other device) to perform one or more operations in accordance with the described methods.

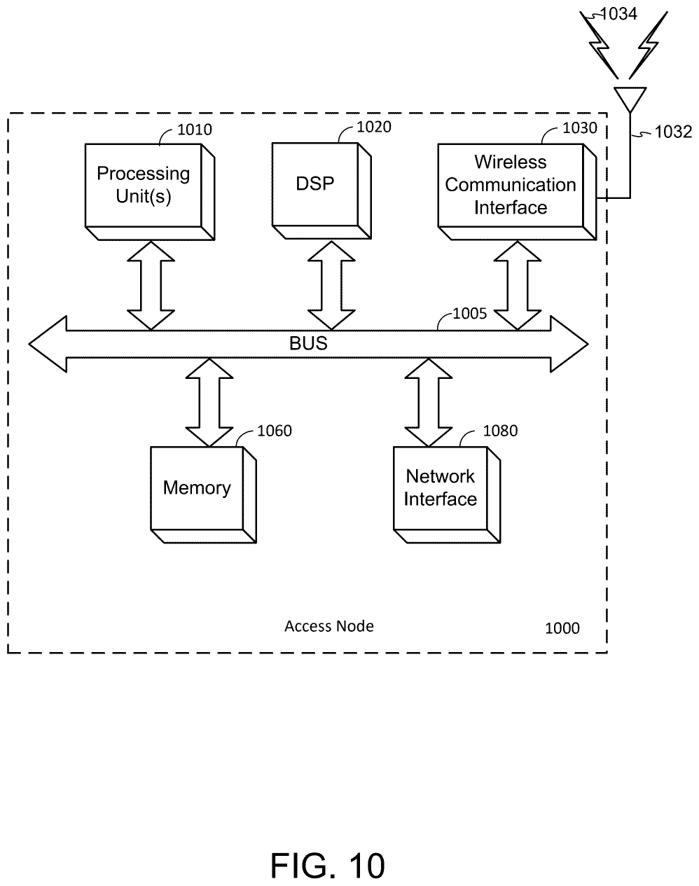

FIG. 10 illustrates an embodiment of an access node 1000. As described above with reference to FIG. 2, an 5G NR positioning/sensing system may be configured to determine the location of a UE, such as, for example, the UE 205, by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1.

The access node 1000 can be utilized in various ways as described above (e.g., in association with FIGS. 1-8). It should be noted that FIG. 10 is meant only to provide a generalized illustration of various components, any or all of which may be utilized as appropriate. The access node 1000 is shown comprising hardware elements that can be electrically coupled via a bus 1005 (or may otherwise be in communication, as appropriate). The hardware elements may include a processing unit(s) 1010 which can include without limitation one or more general-purpose processors, one or more special-purpose processors (such as DSP chips, graphics acceleration processors, ASICs, and/or the like), and/or other processing structure or means. As shown in FIG. 10, some embodiments may have a separate DSP 1020, depending on desired functionality. Operations such as, for example, obtaining information about landmarks and/or evaluating landmarks, that may be based on wireless communication can be provided in the processing unit(s) 1010 and/or wireless communication interface 1030 according to some embodiments.

The wireless communication interface 1030 may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the access node 1000 to communicate as described herein. The wireless communication interface 1030 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1032 that send and/or receive wireless signals 1034.

The access node 1000 may also include a network interface 1080, which can include support of wireline communication technologies. The network interface 1080 may include a modem, network card, chipset, and/or the like. The network interface 1080 may include one or more input and/or output communication interfaces to permit data to be exchanged with a network, communication network servers, computer systems, and/or any other electronic devices described herein.

In many embodiments, the access node 1000 may further comprise a memory 1060. The memory 1060 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1060 of the access node 1000 also may comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the access node 1000 (and/or processing unit(s) 1010 or DSP 1020 within access node 1000). In an aspect, then such code and/or instructions can be used to configure and/or adapt a general-purpose computer (or other device) to perform one or more operations in accordance with the described methods.

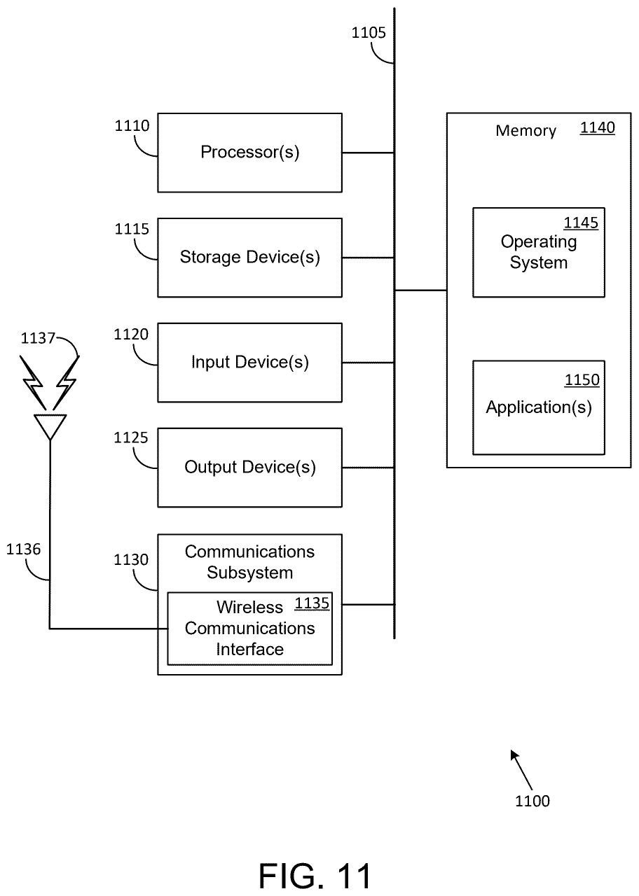

FIG. 11 is a block diagram of an embodiment of a computer system 1100, which may be used, in whole or in part, to provide the functions of one or more components and/or devices as described in the embodiments herein. The computer system 1100, for example, may be utilized within and/or executed by a server (e.g., LMF 220). It should be noted that FIG. 11 is meant only to provide a generalized illustration of various components, any or all of which may be utilized as appropriate. FIG. 11, therefore, broadly illustrates how individual system elements may be implemented in a relatively separated or relatively more integrated manner. In addition, it can be noted that components illustrated by FIG. 11 can be localized to a single device and/or distributed among various networked devices, which may be disposed at different geographical locations.

The computer system 1100 is shown comprising hardware elements that can be electrically coupled via a bus 1105 (or may otherwise be in communication, as appropriate). The hardware elements may include processor(s) 1110, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1100 also may comprise one or more input devices 1120, which may comprise without limitation a mouse, a keyboard, a camera, a microphone, and/or the like; and one or more output devices 1125, which may comprise without limitation a display device, a printer, and/or the like.

The computer system 1100 may further include (and/or be in communication with) one or more non-transitory storage devices 1115, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1100 may also include a communications subsystem 1130, which may comprise wireless communication technologies managed and controlled by a wireless communication interface 1135, as well as wired technologies (such as Ethernet, coaxial communications, universal serial bus (USB), and the like). The wireless communication interface 1135 may comprise one or more wireless transceivers that may send and receive wireless signals 1137 (e.g., signals according to 5G NR or LTE) via wireless antenna(s) 1136. Thus the communications subsystem 1130 may comprise a modem, a network card (wireless or wired), an infrared communication device, a wireless communication device, and/or a chipset, and/or the like, which may enable the computer system 1100 to communicate on any or all of the communication networks described herein to any device on the respective network, including UE, base stations and/or other transmission reception points (TRPs), satellites, and/or any other electronic devices described herein. Hence, the communications subsystem 1130 may be used to receive and send data as described in the embodiments herein.

In many embodiments, the computer system 1100 will further comprise a memory 1140, which may comprise a RAM or ROM device, as described above. Software elements, shown as being located within the memory 1140, may comprise an operating system 1145, device drivers, executable libraries, and/or other code, such as one or more applications 1150, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1115 described above. In some cases, the storage medium might be incorporated within a computer system, such as computer system 1100. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 1100 and/or might take the form of source and/or installable code, which, upon compilation and/or installation on the computer system 1100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

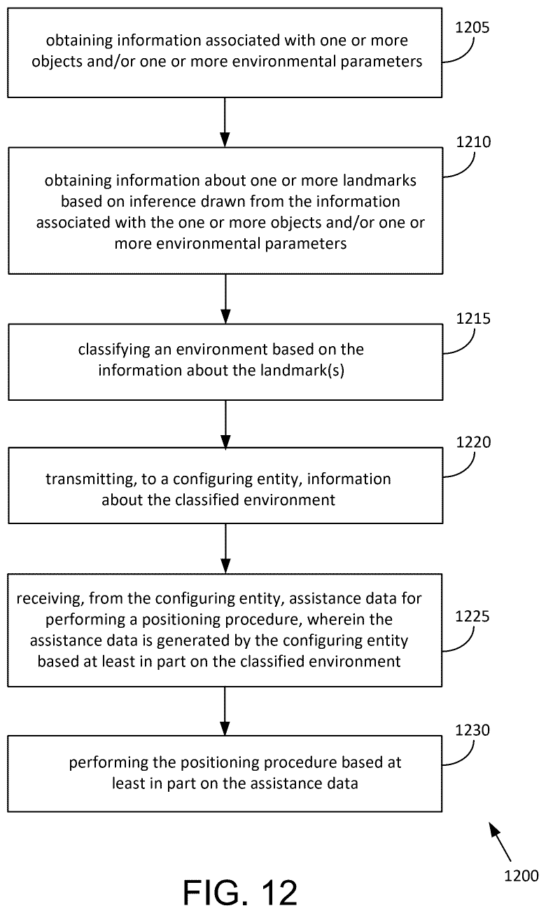

FIG. 12 shows a flowchart 1200 of an example method to perform a positioning operation based on environmental information in accordance with the disclosure. Means for performing the functionality illustrated in one or more of the blocks of the flowchart 1200 may be performed by hardware and/or software components of a user equipment such as described herein with reference to the UE 205.

At block 1205, the functionality can include obtaining information associated with one or more objects and/or one or more environmental parameters. Means and/or structure for performing functionality at block 1205 may comprise a UE that includes a detection system (such as, for example, UE 205 that includes the detection system 265 illustrated in FIG. 2). In an example embodiment, information associated with the object(s) can be obtained, for example, in the form of one or more images captured by a camera. Information associated with one or more environmental parameters can be obtained, for example, in the form of one or more audio signals captured by a microphone and/or one or more sensor signals obtained via one or more sensors.

At block 1210, the functionality can include obtaining information about one or more landmarks based on inference drawn from the information associated with the one or more objects and/or one or more environmental parameters. Means and/or structure for performing functionality at block 1205 may comprise a UE that includes a processor and a memory (such as, for example UE 205 that includes the processor(s) 910 and the memory 960 as illustrated in FIG. 9).

In an example implementation, a UE can obtain information about one or more landmarks based on inference drawn from the information associated with one or more objects. The functionality indicated at block 1210, particularly in terms of drawing inference, may be performed by a processor based on, for example, an artificial intelligence/machine learning (AI/ML) procedure, historical information obtained over a period of time, and/or crowdsourced information provided by one or more other UEs.

In an example scenario, a landmark may be identified as a railway tunnel or a subway station based on inference drawn from objects such as, for example, a train or a railway fixture (signal, railway platform, railway track etc.) present in one or more images captured by an imaging device of the UE.

As another example, a landmark may be identified as a railway tunnel or a subway station based on inference drawn from an environmental parameter in the form of an audio sample captured by a microphone. The audio sample may include, for example, a train whistle or the sound of wheels moving over a railway track. In this case, identifying the landmark as a railway tunnel or a subway station may be based on evaluating one or more audio characteristics of the audio sample (reverberation, echo, tone, and/or other audio spectral characteristic).

At block 1215, the functionality can include classifying an environment based on the information about the landmark. In an example implementation, the environment may be classified in terms of a rating system that classifies the environment on the basis of suitability for performing a positioning procedure. Thus, a railway tunnel or a subway station may be provided a low rating for purposes of the UE performing a positioning procedure. In another example implementation, the environment may be classified in terms of temporal and/or spatial parameters with respect to the one or more landmarks. In an example scenario, the UE may be located outside a railway tunnel at a first instant in time and the environment outside the railway tunnel may have little, or no impact upon the UE performing a positioning procedure. The environment may therefore be classified as a friendly environment. The classification may be provided, for example, in the form of a first label. However, the UE may be located inside the railway tunnel at a second instant in time and the environment inside the railway tunnel may have significant impact upon the UE performing a positioning procedure. The environment may therefore be classified as an unfriendly environment. The classification in this scenario may be provided, for example, in the form of a second label.

In another example scenario, the UE may be located outside a railway tunnel and have a large spatial separation distance from the railway tunnel. In this scenario, the environment may have little, or no impact upon the UE performing a positioning procedure. The environment may therefore be classified as a friendly environment. The classification in this scenario may be provided, for example, in the form of a third label.

The functionality described above with reference to block 1215 (classifying the environment) may be alternatively implemented based on information about one or more landmarks that may be obtained in ways other than indicated at block 1205 and block 1210. Thus, for example, an environment may be classified based on crowdsourced information about the one or more landmarks.

At block 1220, the functionality can include transmitting, to a configuring entity, information about the classified environment (such as, for example a rating or a classification as described above). Means and/or structure for performing functionality at block 1220 may comprise a UE that includes a transmitter (or transceiver), such as, for example UE 205 that includes a wireless communication interface 930 illustrated in FIG. 9 and described below.

At block 1225, the functionality can include receiving, from the configuring entity, assistance data for performing a positioning procedure, wherein the assistance data is generated by the configuring entity based at least in part on the classified environment. Means and/or structure for performing functionality at block 1225 may comprise a UE that includes a receiver (or transceiver) such as, for example UE 205 that includes a wireless communication interface 930 illustrated in FIG. 9 and described below. In an example scenario, the assistance data may provide information about devices such as, for example, access nodes and APs that are located near the landmark or located inside the landmark (inside a railway tunnel, for example).

At block 1230, the functionality can include performing the positioning procedure based at least in part, on the assistance data received from the configuring entity. Means and/or structure for performing the functionality at block 1230 may comprise a UE that includes a processor and a memory (such as, for example UE 205 that includes the processor(s) 910 and the memory 960 as illustrated in FIG. 9). In an example implementation, the UE may perform the positioning procedure based on using a reference signal that is indicated as information in the assistance data. The reference signal may be provided by an entity such as, for example, gNB 210.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1 A method performed by a first user equipment (UE) for positioning, the method comprising obtaining information associated with one or more landmarks; determining at least one of an identification or a classification of at least one of the one or more landmarks; transmitting, to a configuring entity, the at least one of the identification or the classification; receiving, from the configuring entity, assistance data for performing a positioning procedure, wherein the assistance data is generated by the configuring entity based at least in part on the at least one of the identification or the classification; and performing the positioning procedure based at least in part on the assistance data.

Clause 2 The method of clause 1, wherein determining the at least one of the identification or the classification is based at least in part, on performing an artificial intelligence/machine learning (AI/ML) procedure.

Clause 3 The method of either clause 1 or clause 2, wherein the configuring entity is one of a location server or an access node, and wherein determining the at least one of the identification or the classification is based at least in part on a predefined list of landmark types.

Clause 4 The method of any of clause 1 through clause 3, wherein the at least one of the identification or the classification provides an indication that the at least one of the one or more landmarks is one of a man-made structure or a natural object.

Clause 5 The method of any of clause 1 through clause 4, wherein obtaining the information associated with the one or more landmarks is based on at least one of one or more images captured by a camera, one or more audio signals obtained via a microphone, one or more sensor signals obtained from a sensor, crowdsourced information about the one or more landmarks received from one or more devices, or location measurements associated with the one or more landmarks.

Clause 6 The method of any of clause 1 through clause 4, wherein obtaining information associated with the one or more landmarks is based at least in part on communications with at least one of a second UE or a network entity, the communications conforming to one or more positioning protocols, the one or more positioning protocols including at least one of an LTE Positioning Protocol (LPP) or a Sidelink Positioning Protocol (SLPP).

Clause 7 The method of any of clause 1 through clause 6, wherein the configuring entity is one of a location server or an access node, and wherein the method further comprises receiving, from the one of the location server or the access node, one of a request for capability information of the first UE or a request for a landmark identification capability of the first UE; and transmitting, to the one of the location server or the access node, a ProvideCapabilities message responsive to the one of the request for capability information or the request for the landmark identification capability, the ProvideCapabilities message comprising an indication of the landmark identification capability of the first UE.

Clause 8 The method of any of clause 1 through clause 7, wherein transmitting, to the configuring entity, the at least one of the identification or the classification, comprises transmitting, to the configuring entity, the at least one of the identification or the classification in at least one of a RequestAssistanceData message requesting the assistance data from the configuring entity or a ProvideLocationInformation message that includes location information of the first UE.

Clause 9 The method of any of clause 1 through clause 8, further comprising receiving, from the configuring entity, a request for performing the positioning procedure, wherein the request for performing the positioning procedure comprises an indication of one or more location measurements to be obtained inside a defined geographic area that includes the at least one of the one or more landmarks; and obtaining the one or more location measurements based at least in part on using the assistance data to perform the positioning procedure.

Clause 10 The method of any of clause 1 through clause 9, wherein performing the positioning procedure comprises performing a radio-based positioning procedure.

Clause 11 The method of clause 10, wherein performing the radio-based positioning procedure is based, at least in part, on one or more reference signals indicated in the assistance data, the one or more reference signals comprising at least one of a WiFi reference signal, a 4G LTE reference signal, a 5G NR reference signal, a 6G reference signal, a GNSS navigation signal, or a sidelink reference signal.

Clause 12 The method of clause 10, wherein performing the radio-based positioning procedure is based on at least one of a WiFi access point, a 4G LTE eNode B, a 5G NR gNodeB, a GNSS satellite, or a second UE that is indicated in the assistance data.

Clause 13 A first user equipment (UE) for performing positioning, comprising at least one transceiver; at least one memory; and one or more processors communicatively coupled with the at least one transceiver and the at least one memory, the one or more processors configured to obtain, via the at least one transceiver, information associated with one or more landmarks; determine at least one of an identification or a classification of at least one of the one or more landmarks; transmit, via the at least one transceiver, to a configuring entity, the at least one of the identification or the classification; receive, via the at least one transceiver, from the configuring entity, assistance data for performing a positioning procedure, wherein the assistance data is generated by the configuring entity based at least in part on the at least one of the identification or the classification; and perform the positioning procedure based on configuring the first UE.

Clause 14 The first UE of clause 13, wherein to obtain the information associated with the one or more landmarks, the one or more processors are configured to obtain the information associated with the one or more landmarks based on at least one of one or more images captured by a camera, one or more audio signals obtained via a microphone, one or more sensor signals obtained from a sensor, crowdsourced information about the one or more landmarks received from one or more devices, or location measurements associated with the one or more landmarks.

Clause 15 The first UE of either clause 13 or clause 14, wherein to determine the at least one of the identification or the classification of the at least one of the one or more landmarks, the one or more processors are further configured to identify the at least one of the one or more landmarks based at least in part on performing an artificial intelligence/machine learning (AI/ML) procedure.

Clause 16 The first UE of clause 13, wherein to obtain the information associated with the one or more landmarks, the one or more processors are configured to obtain the information associated with the one or more landmarks based at least in part on communications with at least one of a second UE or a network entity, the communications conforming to one or more positioning protocols, the one or more positioning protocols including at least one of an LTE Positioning Protocol (LPP) or a Sidelink Positioning Protocol (SLPP).

Clause 17 The first UE of any of clause 13 through clause 16, wherein the configuring entity is one of a location server or an access node, and wherein the one or more processors are further configured to receive, via the at least one transceiver, from the one of the location server or the access node, one of a request for capability information of the first UE or a request for a landmark identification capability of the first UE; and transmit, via the at least one transceiver, to the one of the location server or the access node, a ProvideCapabilities message responsive to the one of the request for capability information or the request for the landmark identification capability, the ProvideCapabilities message comprising an indication of the landmark identification capability of the first UE.

Clause 18 The first UE of any of clause 13 through clause 17, wherein the one or more processors are further configured to transmit, via the at least one transceiver, to the configuring entity, information associated with the one or more landmarks in at least one of a RequestAssistanceData message requesting assistance data from the configuring entity or a ProvideLocationInformation message that includes location information of the first UE.

Clause 19 The first UE of any of clause 13 through clause 18, wherein the one or more processors are further configured to receive, via the at least one transceiver, from the configuring entity, a request for performing the positioning procedure, wherein the request for performing the positioning procedure comprises an indication of one or more location measurements to be obtained inside a defined geographic area that includes the one or more landmarks; and obtain the one or more location measurements based at least in part on using the assistance data to perform the positioning procedure.

Clause 20 An apparatus for providing location services, the apparatus comprising means for obtaining information associated with one or more landmarks means for determining at least one of an identification or a classification of at least one of the one or more landmarks; means for transmitting, to a configuring entity, the at least one of the identification or the classification; means for receiving, from the configuring entity, assistance data for performing a positioning procedure, wherein the assistance data is generated by the configuring entity based at least in part on the at least one of the identification or the classification; and means for performing the positioning procedure based at least in part on the assistance data.

Clause 21 A method performed by a configuring entity for providing assistance data, the method comprising receiving, from a first user equipment (UE), at least one of an identification or a classification of at least one of one or more landmarks; generating, based at least in part on the at least one of an identification or a classification, at least one of a reference signal for performing a positioning procedure or assistance data for performing the positioning procedure; and transmitting, to the first UE, the at least one of the reference signal for performing the positioning procedure or assistance data for performing the positioning procedure.

Clause 22 The method of clause 21, further comprising receiving, from a second UE, information about the one or more landmarks that is obtained by the second UE; and validating the assistance data provided to the first UE, based on the information about the one or more landmarks received from the second UE.

Clause 23 The method of either clause 21 or clause 22, wherein the assistance data comprises an indication of one or more network entities that support the first UE perform the positioning procedure.

Clause 24 The method of any of clause 21 through clause 23, wherein the one or more network entities are selected from a plurality of network entities based on evaluating a suitability of one or more of the plurality of network entities for enabling the first UE perform the positioning procedure.

Clause 25 The method of clause 24, wherein evaluating the suitability of the one or more of the plurality of network entities for enabling the first UE perform the positioning procedure comprises evaluating a map of a cellular service area and determining an availability of location services support by the one or more of the plurality of network entities in the cellular service area.

Clause 26 The method of any of clause 21 through clause 25, further comprising receiving, from the first UE, a capability report that indicates a landmark detection capability of the first UE.

Clause 27 The method of clause 26, wherein generating assistance data is conditional to receiving the capability report from the first UE.

Clause 28 The method of any of clause 21 through clause 27, wherein the configuring entity is a location server, the method further comprising identifying, based at least in part on the information associated with the landmark, at least one access node having a capability to provide to the first UE, the reference signal for performing the positioning procedure; and arranging for the at least one access node to provide to the first UE, the reference signal.

Clause 29 The method of any of clause 21 through clause 27, wherein the configuring entity is a location server, the method further comprising identifying, based at least in part on the at least one of the identification or the classification of the at least one of the one or more landmarks, at least one of a measurement schedule or a measurement periodicity; and including, in the assistance data, information associated with the at least one of the measurement schedule or the measurement periodicity.

Clause 30 The method of any of clause 21 through clause 27, wherein the configuring entity is one of a location server or an access node, and wherein the assistance data received from the one of the location server or the access node provides an identification of one or more entities to be used by the first UE for performing the positioning procedure.

Clause 31 A configuring entity for providing assistance data, comprising at least one transceiver; at least one memory; and one or more processors communicatively coupled with the at least one transceiver and the at least one memory, the one or more processors configured to receive, via the at least one transceiver, from a first user equipment (UE), information about a landmark that is causing a disruption in a first mode of cellular communications used by the UE; generate, based at least in part on the information associated with the landmark, at least one of a reference signal for performing a positioning procedure or assistance data for performing the positioning procedure; and transmit, via the at least one transceiver, to the first UE, the at least one of the reference signal for performing the positioning procedure or assistance data for performing the positioning procedure.

Clause 32 The configuring entity of clause 31, wherein the one or more processors are further configured to receive, from a second UE, information about the one or more landmarks that is obtained by the second UE; and validating the assistance data provided to the first UE, based on the information about the one or more landmarks received from the second UE

Clause 33 The configuring entity of either clause 31 or clause 32, wherein the assistance data comprises an indication of one or more network entities that support the first UE perform the positioning procedure.

Clause 34 The configuring entity of any of clause 31 through clause 33, wherein the one or more network entities are selected from a plurality of network entities based on evaluating a suitability of one or more of the plurality of network entities for enabling the first UE perform the positioning procedure.

Clause 35 The configuring entity of clause 34, wherein evaluating the suitability of the one or more of the plurality of network entities for enabling the first UE perform the positioning procedure comprises evaluating a map of a cellular service area and determining an availability of location services support by the one or more of the plurality of network entities in the cellular service area

Clause 36 The configuring entity of any of clause 31 through clause 35, further comprising receiving, from the first UE, a capability report that indicates a landmark detection capability of the first UE.

Clause 37 The configuring entity of clause 36, wherein generating assistance data is conditional to receiving the capability report from the first UE.

Clause 38 The configuring entity of any of clause 31 through clause 37, wherein the configuring entity is a location server, the method further comprising identifying, based at least in part on the information associated with the landmark, at least one access node having a capability to provide to the first UE, the reference signal for performing the positioning procedure; and arranging for the at least one access node to provide to the first UE, the reference signal.

Clause 39 An apparatus for providing assistance data, the apparatus comprising means for receiving, from a first user equipment (UE), at least one of an identification or a classification of at least one of one or more landmarks; means for generating, based at least in part on the at least one of an identification or a classification, at least one of a reference signal for performing a positioning procedure or assistance data for performing the positioning procedure; and means for transmitting, to the first UE, the at least one of the reference signal for performing the positioning procedure or assistance data for performing the positioning procedure.

What is claimed is:

1. A method performed by a first user equipment (UE) for positioning, the method comprising:
obtaining information associated with one or more landmarks;
determining at least one of an identification or a classification of at least one of the one or more landmarks;
transmitting, to a configuring entity, the at least one of the identification or the classification;
receiving, from the configuring entity, assistance data for performing a positioning procedure, wherein the assistance data is generated by the configuring entity based at least in part on the at least one of the identification or the classification; and
performing the positioning procedure based at least in part on the assistance data.

2. The method of claim 1, wherein determining the at least one of the identification or the classification is based at least in part, on performing an artificial intelligence/machine learning (AI/ML) procedure.

3. The method of claim 1, wherein the configuring entity is one of a location server or an access node, and wherein determining the at least one of the identification or the classification is based at least in part on a predefined list of landmark types.

4. The method of claim 1, wherein the at least one of the identification or the classification provides an indication that the at least one of the one or more landmarks is one of a man-made structure or a natural object.

5. The method of claim 1, wherein obtaining the information associated with the one or more landmarks is based on at least one of one or more images captured by a camera, one or more audio signals obtained via a microphone, one or more sensor signals obtained from a sensor, crowdsourced information about the one or more landmarks received from one or more devices, or location measurements associated with the one or more landmarks.

6. The method of claim 1, wherein obtaining information associated with the one or more landmarks is based at least in part on communications with at least one of a second UE or a network entity, the communications conforming to one or more positioning protocols, the one or more positioning protocols including at least one of an LTE Positioning Protocol (LPP) or a Sidelink Positioning Protocol (SLPP).

7. The method of claim 1, wherein the configuring entity is one of a location server or an access node, and wherein the method further comprises:
receiving, from the one of the location server or the access node, one of a request for capability information of the first UE or a request for a landmark identification capability of the first UE; and
transmitting, to the one of the location server or the access node, a ProvideCapabilities message responsive to the one of the request for capability information or the request for the landmark identification capability, the ProvideCapabilities message comprising an indication of the landmark identification capability of the first UE.

8. The method of claim 1, wherein transmitting, to the configuring entity, the at least one of the identification or the classification, comprises transmitting, to the configuring entity, the at least one of the identification or the classification in at least one of a RequestAssistanceData message requesting the assistance data from the configuring entity or a ProvideLocationInformation message that includes location information of the first UE.

9. The method of claim 1, further comprising:
receiving, from the configuring entity, a request for performing the positioning procedure, wherein the request for performing the positioning procedure comprises an indication of one or more location measurements to be obtained inside a defined geographic area that includes the at least one of the one or more landmarks; and
obtaining the one or more location measurements based at least in part on using the assistance data to perform the positioning procedure.

10. The method of claim 1, wherein performing the positioning procedure comprises performing a radio-based positioning procedure.

11. The method of claim 10, wherein performing the radio-based positioning procedure is based, at least in part, on one or more reference signals indicated in the assistance data, the one or more reference signals comprising at least one of a WiFi reference signal, a 4G LTE reference signal, a 5G NR reference signal, a 6G reference signal, a GNSS navigation signal, or a sidelink reference signal.

12. The method of claim 10, wherein performing the radio-based positioning procedure is based on at least one of a WiFi access point, a 4G LTE eNode B, a 5G NR gNodeB, a GNSS satellite, or a second UE that is indicated in the assistance data.

13. A first user equipment (UE) for performing positioning, comprising:
at least one transceiver;
at least one memory; and
one or more processors communicatively coupled with the at least one transceiver and the at least one memory, the one or more processors configured to:
obtain, via the at least one transceiver, information associated with one or more landmarks;
determine at least one of an identification or a classification of at least one of the one or more landmarks;
transmit, via the at least one transceiver, to a configuring entity, the at least one of the identification or the classification;
receive, via the at least one transceiver, from the configuring entity, assistance data for performing a positioning procedure, wherein the assistance data is generated by the configuring entity based at least in part on the at least one of the identification or the classification; and
perform the positioning procedure based on configuring the first UE.

14. The first UE of claim 13, wherein to obtain the information associated with the one or more landmarks, the one or more processors are configured to:
obtain the information associated with the one or more landmarks based on at least one of one or more images captured by a camera, one or more audio signals obtained via a microphone, one or more sensor signals obtained from a sensor, crowdsourced information about the one or more landmarks received from one or more devices, or location measurements associated with the one or more landmarks.

15. The first UE of claim 14, wherein to determine the at least one of the identification or the classification of the at least one of the one or more landmarks, the one or more processors are further configured to:
identify the at least one of the one or more landmarks based at least in part on performing an artificial intelligence/machine learning (AI/ML) procedure.

16. The first UE of claim 13, wherein to obtain the information associated with the one or more landmarks, the one or more processors are configured to:
obtain the information associated with the one or more landmarks based at least in part on communications with at least one of a second UE or a network entity, the communications conforming to one or more positioning protocols, the one or more positioning protocols including at least one of an LTE Positioning Protocol (LPP) or a Sidelink Positioning Protocol (SLPP).

17. The first UE of claim 13, wherein the configuring entity is one of a location server or an access node, and wherein the one or more processors are further configured to:
receive, via the at least one transceiver, from the one of the location server or the access node, one of a request for capability information of the first UE or a request for a landmark identification capability of the first UE; and
transmit, via the at least one transceiver, to the one of the location server or the access node, a ProvideCapabilities message responsive to the one of the request for capability information or the request for the landmark identification capability, the ProvideCapabilities message comprising an indication of the landmark identification capability of the first UE.

18. The first UE of claim 13, wherein the one or more processors are further configured to:
transmit, via the at least one transceiver, to the configuring entity, information associated with the one or more landmarks in at least one of a RequestAssistanceData message requesting assistance data from the configuring entity or a ProvideLocationInformation message that includes location information of the first UE.

19. The first UE of claim 13, wherein the one or more processors are further configured to:
receive, via the at least one transceiver, from the configuring entity, a request for performing the positioning procedure, wherein the request for performing the positioning procedure comprises an indication of one or more location measurements to be obtained inside a defined geographic area that includes the one or more landmarks; and
obtain the one or more location measurements based at least in part on using the assistance data to perform the positioning procedure.

20. An apparatus for providing location services, the apparatus comprising:
means for obtaining information associated with one or more landmarks;
means for determining at least one of an identification or a classification of at least one of the one or more landmarks;
means for transmitting, to a configuring entity, the at least one of the identification or the classification;
means for receiving, from the configuring entity, assistance data for performing a positioning procedure, wherein the assistance data is generated by the configuring entity based at least in part on the at least one of the identification or the classification; and
means for performing the positioning procedure based at least in part on the assistance data.
